(19) United States
(12) Patent Application Publication
(10) Pub. No.: US 2020/0226659 A1
(43) Pub. Date: Jul. 16, 2020

(54) INFORMATION PROCESSING TERMINAL, INFORMATION PROVIDING SERVER, AND INFORMATION PROVIDING METHOD

(71) Applicant: TOSHIBA TEC KABUSHIKI KAISHA, Tokyo (JP)

(72) Inventor: Shinichi SHIMOIRISA, Mishima Shizuoka (JP)

(21) Appl. No.: 16/681,499

(22) Filed: Nov. 12, 2019

(30) Foreign Application Priority Data
Jan. 11, 2019 (JP) 2019-003448

(51) Int. Cl. G06Q 30/06; G06F 16/28; G06F 16/25; G06F 16/248

(52) U.S. Cl. CPC G06Q 30/0631; G06F 16/248; G06F 16/252; G06F 16/285

(57) ABSTRACT

According to an embodiment, an information providing server performs an information providing service for providing information regarding a recommended dish suitable for cooking using a food that a customer has. The information providing server includes a processor and a storage device. The processor outputs dish data regarding the recommended dish on the basis of a list of foods that the customer has and data records stored in a dish database stored in the storage device. The processor then outputs presentation data including sales information regarding a food item lacking for cooking the recommended dish in a store.

### CROSS-REFERENCE TO RELATED APPLICATIONS

This application is based upon and claims the benefit of priority from the prior Japanese Patent Application No. 2019-003448, filed on Jan. 11, 2019, the entire contents of which are incorporated herein by reference.

### FIELD

An embodiment to be described here generally relates to an information processing terminal, an information providing server, and an information providing method.

### BACKGROUND

With the recent progress of Internet of Things (IoT), refrigerators each having a function as an information terminal have appeared. Research is underway to make this type of refrigerator have a function of outputting various types of data related to foods stored in the refrigerator. For example, research is underway to make this type of refrigerator have a function of proposing a dish suitable for cooking using the stored foods. However, in some instances, not all foods necessary for a user to cook the dish proposed by the refrigerator are presently stored in the refrigerator. The user needs to first acquire missing food items in some cases in order to cook the dish proposed by the refrigerator. In the case where the user needs to add missing food items as described above, it would be convenient if the user could know the sales situation of these foods at a store. In view of the above-mentioned circumstances, there has been a demand for a mechanism in a refrigerator, which is capable of proposing a dish and providing a user with information regarding the purchase of the missing foods required for cooking the dish.

### BRIEF DESCRIPTION OF THE DRAWINGS

FIG. 1 is a block diagram illustrating a schematic configuration of an information providing system according to an embodiment and a circuit configuration of a main part of a refrigerator terminal and an information providing server included in the information providing system.

FIG. 2 is a diagram schematically showing a structure of a data record included in a store database according to the embodiment.

FIG. 3 is a diagram schematically showing a structure of a data record included in a user database according to the embodiment.

FIG. 4 is a diagram schematically showing a structure of a data record included in a food database according to the embodiment.

FIG. 5 is a diagram schematically showing a structure of a data record included in a dish database according to the embodiment.

FIG. 6 is a flowchart illustrating information processing related to a dish proposal by a processor of a refrigerator terminal according to the embodiment.

FIG. 7 is a flowchart illustrating information processing related to a dish proposal by a processor of an information providing server according to the embodiment.

FIG. 8 is a diagram showing a proposal screen of the refrigerator terminal according to the embodiment.

### DETAILED DESCRIPTION

According to an embodiment, an information providing server performs an information providing service for providing information regarding a recommended dish suitable for cooking using food that a customer has on hand. The information providing server includes a communication interface, a storage device, a memory, and a processor. The communication interface communicates with an information processing terminal and a store server. The information processing terminal manages/tracks the food that the customer has on hand. The store server manages information for a store that sells food. The storage device stores a dish database. The dish database includes a plurality of data records associated with a plurality of dishes. A classification code is set in each of the plurality of data records. The classification code is capable of identifying the food necessary for cooking a dish associated with a corresponding data record. The memory stores an information processing program for performing the information providing service. The processor acquires a list of classification codes identifying the food that the customer has on hand. The list is acquired in accordance with the information processing program from the information processing terminal via the communication interface. The processor determines the recommended dish on a basis of the classification codes in the list and the classification code set in each of the plurality of data records of the dish database. The processor then selects, on a basis of the classification codes in the list and the classification code set in the data record associated with the determined recommended dish, a food item that the customer is presently lacking but is required for cooking the recommended dish. The processor acquires, from the store server via the communication interface, store sales information regarding the selected lacking food item. The processor then outputs, to the information processing terminal via the communication interface, dish data regarding the determined recommended dish and presentation data including the acquired sales information.

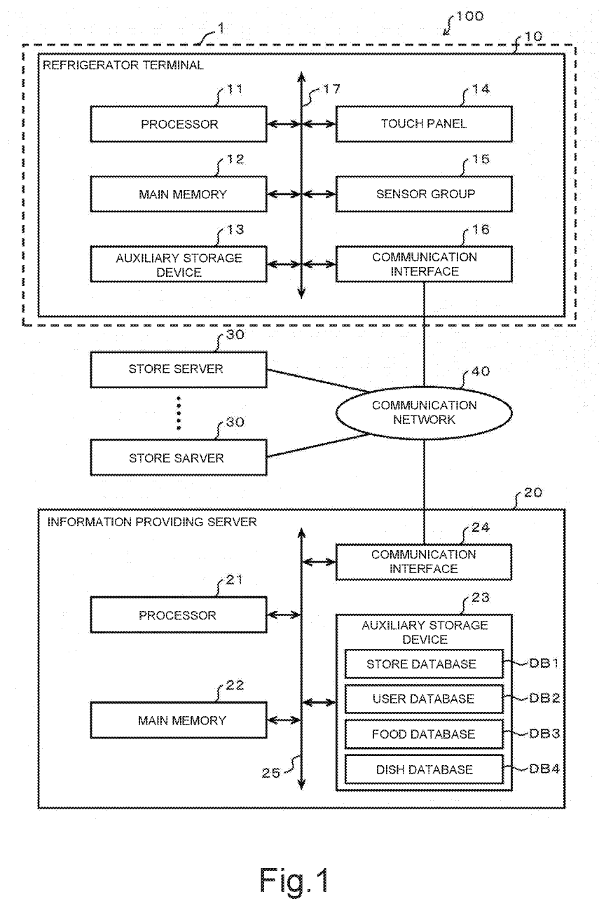

Hereinafter, an example embodiment will be described with reference to the drawings. In the drawings, the same reference symbols indicate the same or similar components. FIG. 1 is a block diagram illustrating a schematic configuration of an information providing system 100 according to an embodiment and a circuit configuration of a main part of an information processing terminal 10 and an information providing server 20 included in the information providing system 100.

The information providing system 100 includes the information processing terminal 10, the information providing server 20, and a plurality of store servers 30. The information processing terminal 10, the information providing server 20, and the plurality of store servers 30 are capable of communicating with each other via a communication network 40. As the communication network 40, the Internet a virtual private network (VPN), a local area network (LAN), a public communication network, a mobile communication network, and the like can be used alone or in appropriate combination. Note that although the information providing system 100 typically includes a plurality of information processing terminals 10, only one information processing terminal 10 is shown in FIG. 1.

The information processing terminal 10 is an information processing apparatus attached to a food storage apparatus 1. The information processing terminal 10 may be built into the food storage apparatus 1 or may be externally attached to the food storage apparatus 1. The food storage apparatus 1 can be installed in a home or the like of a customer who uses an information providing service provided by the information providing system 100. The food storage apparatus 1 is, for example, a refrigerator that stores and refrigerates foods that the user has. In the following description, the customer who uses this information providing service can be referred to simply as a user in some cases. Further, the food storage apparatus 1 is referred to as the refrigerator 1. Further, information processing terminal 10 can be referred to as refrigerator terminal 10. The refrigerator terminal 10 manages (tracks) the foods stored in the refrigerator 1. Further, the refrigerator terminal 10 functions as a user interface for the user to browse information provided by the information providing service. The information providing server 20 provides the user with the information providing service. The information providing service is a service for presenting data provided by the store server 30, which is a proposal of a dish suitable for cooking using the foods managed by the refrigerator terminal 10. Each of the store servers 30 is associated with a store that sells food items. The store server 30 is typically installed in each store that sells food items. However, the store server 30 may be provided at a place different from the store associated with the store server 30. The store server 30 notifies, in response to a request from the refrigerator terminal 10, the refrigerator terminal 10 of data regarding the sale of food items in the store associated with the store server 30.

The refrigerator terminal 10 includes a processor 11, a main memory 12, an auxiliary storage device 13, a touch panel 14, a sensor group 15, a communication interface 16, the transmission path 17, and the like. The processor 11, the main memory 12, the auxiliary storage device 13, the touch panel 14, the sensor group 15, and the communication interface 16 are connected to each other via the transmission path 17. In the refrigerator terminal 10, the processor 11, the main memory 12, and the auxiliary storage device 13 are connected to each other by the transmission path 17, thereby constituting a computer that executes information processing for controlling the refrigerator terminal 10.

The processor 11 corresponds to the brain of the above-mentioned computer. The processor 11 controls, in accordance with an information processing program such as an operating system, middleware, and an application program, the respective units of the refrigerator terminal 10 in order to realize various functions as the refrigerator terminal 10.

The main memory 12 corresponds to the main memory part of the above-mentioned computer. The main memory 12 includes a non-volatile memory area and a volatile memory area. The main memory 12 stores an information processing program in the non-volatile memory area. Further, the main memory 12 stores, in the non-volatile memory area or volatile memory area, data necessary for the processor 11 to execute processing for controlling the respective units in some cases. The main memory 12 is used as a work area in which the processor 11 appropriately rewrites data in the volatile memory area.

The auxiliary storage device 13 corresponds to an auxiliary storage part of the above-mentioned computer. The auxiliary storage device 13 is, for example, an electric erasable programmable read-only memory (EEPROM). A hard disc drive (HDD), a solid state drive (SSD), or the like may be used as the auxiliary storage device 13. The auxiliary storage device 13 stores data to be used by the processor 11 for executing various types of processing, and data generated by the processing executed by the processor 11. Further, the auxiliary storage device 13 stores an information processing program.

The touch panel 14 functions as an input device and a display device of the refrigerator terminal 10. In the case where the refrigerator terminal 10 is built in the refrigerator 1, the touch panel 14 is attached to, for example, the door of the refrigerator 1 in such a way that the display screen can be viewed from the outside of the refrigerator 1. The sensor group 15 includes a plurality of sensors for detecting foods stored in the refrigerator 1. The sensor group 15 may include, for example, a camera, a barcode scanner, a radio frequency identification (RFID) reader, a weight sensor, or the like as the above-mentioned sensor.

The communication interface 16 executes data communication via the communication network 40. As the communication interface 16, for example, a known communication device for executing data communication via the Internet can be used. The transmission path 17 includes an address bus, a data bus, a control signal line, and the like, and transmits data and control signals to be exchanged between the respective units connected to the transmission path 17.

One of the information processing programs stored by the main memory 12 or the auxiliary storage device 13 is an application program describing a procedure of information processing for realizing the function as the refrigerator terminal 10. The information processing program is typically transferred to the user together with the refrigerator terminal 10 or the refrigerator 1 while stored in the main memory 12 or the auxiliary storage device 13. However, the information processing program can be transferred to the user separately from the hardware of the refrigerator terminal 10 and may be later written to the main memory 12 or the auxiliary storage device 13 by the processor 11 under an instruction operation by the user. In this case, the transfer of the information processing program can be realized by recording the information processing program in a removable recording medium such as a magnetic disk, a magneto-optical disk, an optical disk, and a semiconductor memory, or by downloading the information processing program via a network.

The information providing server 20 includes a processor 21, a main memory 22, an auxiliary storage device 23, a communication interface 24, a transmission path 25, and the like. The processor 21, the main memory 22, the auxiliary storage device 23, and the communication interface 24 are connected to each other via the transmission path 25. In the information providing server 20, the processor 21, the main memory 22, and the auxiliary storage device 23 are connected to each other by the transmission path 25, thereby constituting a computer that executes information processing for controlling the information providing server 20.

The processor 21 corresponds to the brain of the above-mentioned computer. The processor 21 controls, in accordance with an information processing program, the respective units of the information providing server 20 in order to realize various functions as the information providing server 20.

The main memory 22 corresponds to the main memory part of the above-mentioned computer. The main memory 22 includes a non-volatile memory area and a volatile memory area. The main memory 22 stores an information processing program in the non-volatile memory area. Further, the main memory 22 stores, in the non-volatile memory area or volatile memory area, data necessary for the processor 21 to execute processing for controlling the respective units in some cases. The main memory 22 is used as a work area in which the processor 21 appropriately rewrites data in the volatile memory area.

The auxiliary storage device 23 corresponds to an auxiliary storage part of the above-mentioned computer. The auxiliary storage device 23 is, for example, an EEPROM, an HDD, or an SSD. The auxiliary storage device 23 stores data to be used by the processor 21 for executing various types of processing, and data generated by the processing executed by the processor 21. Further, the auxiliary storage device 23 stores an information processing program in some cases.

The communication interface 24 executes data communication via the communication network 40. As the communication interface 24, for example, a known communication device for executing data communication via the Internet can be used. The transmission path 25 includes an address bus, a data bus, a control signal line, and the like, and transmits data and control signals to be exchanged between the respective units connected to the transmission path 25.

As the hardware of the information providing server 20, for example, a general-purpose computer apparatus can be used. One of the information processing programs stored by the main memory 22 or the auxiliary storage device 23 is an application program describing a procedure of information processing for realizing the above-mentioned information providing service. The information processing program is typically transferred to an administrator or the like of the information providing server 20 separately from the hardware of the information providing server 20. In this case, the transfer of the information processing program can be realized by recording the information processing program in a removable recording medium such as a magnetic disk, a magneto-optical disk, an optical disk, and a semiconductor memory, or by downloading the information processing program via a network. Then, the information processing program transferred as described above is written to the main memory 22 or the auxiliary storage device 23 by the processor 21 under an instruction operation by the administrator or the like. However, the information providing server 20 in which the above-mentioned information processing program has been stored in the main memory 22 or the auxiliary storage device 23 included in the computer apparatus as basic hardware may be transferred to the administrator or the like. The data stored by the auxiliary storage device 23 includes a store database DB1, a user database DB2, a food database DB3, and a dish database DB4.

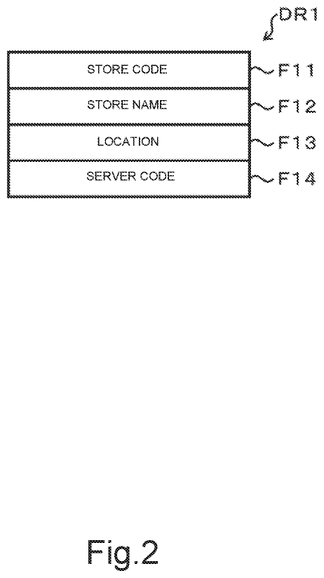

FIG. 2 is a diagram schematically showing a structure of a data record DR1 included in the store database DB1. The store database DB1 is a set of data records DR1 having the structure shown in FIG. 2. One data record DR1 is associated with one store. The data record DR1 includes fields F11, F12, F13, and F14.

In the field F11, a store code for identifying the store associated with the data record DR1 is set. In the field F12, a name (store name) assigned to the store associated with the data record DR1 is set. In the Field F13, a location of the store associated with the data record DR1 is set. Specific data to be set in the field F13 may be data capable of specifying the position of the store with high accuracy, such as house display and longitude and latitude coordinates. Specific data to be set in the field F13 may be data capable of roughly specifying the position of the store, such as an address code, a postal code, an area name, and the nearest train station name. In the field F14, a server code for identifying the store server 30 associated with the store associated with the data record DR1 is set.

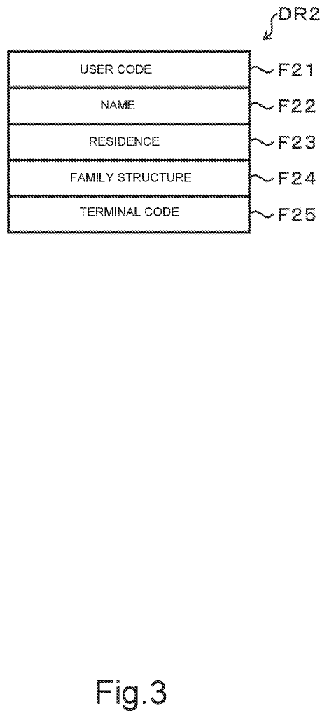

FIG. 3 is a diagram schematically showing a structure of a data record DR2 included in the user database DB2. The user database DB2 is a set of data records DR2 having the structure shown in FIG. 3. One data record DR2 is associated with one user. The data record DR2 includes fields F21, F22, F23, F24, and F25.

In the field F21, a user code for identifying the user associated with the data record DR2 is set. In the field F22, the name of the user associated with the data record DR2 is set. In the field F23, a residence of the user associated with the data record DR2 is set. Specific data to be set in the field F23 may be data capable of specifying the position of the residence with high accuracy, such as house display and longitude and latitude coordinates. Specific data to be set in the field F23 may be data capable of roughly specifying the position of the residence, such as an address code, a postal code, an area name, and the nearest station name. In the field F24, the family structure of the user associated with the data record DR2 is set. In the field F25, a terminal code for identifying the refrigerator terminal 10 used by the user associated with the data record DR2 is set.

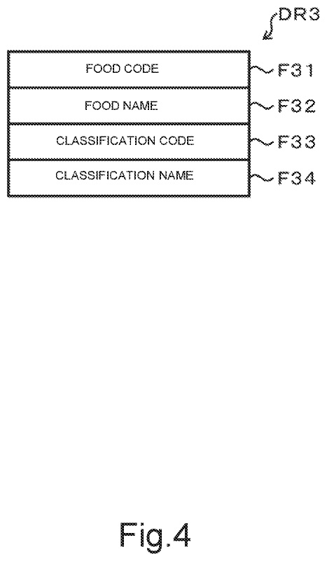

FIG. 4 is a diagram schematically showing a structure of a data record DR3 included in the food database DB3. The food database DB3 is a set of data records DR3 having the structure shown in FIG. 4. One data record DR3 is associated with one food. The data record DR3 includes fields F31, F32, F33, and F34.

In the field F31, a food code for identifying the food associated with the data record DR3 is set. Specifically, the food to be associated with the data record DR3 is a food that can be identified by the food code and is not an individual food among a plurality of foods associated with the same food code. In the field F32, the name (food name) of the food associated with the data record DR3 is set. The name is, for example, a name arbitrarily determined as a product name by a food manufacturer. In the field F33, a classification code for identifying the food classification to which the food associated with the data record DR3 belongs is set. The food classification is determined in advance so that the same type of foods within the meaning of cooking ingredients belongs to the same classification. In the field F34, the name of the food classification to which the food associated with the data record DR3 belongs is set. For example, “sugar” is an example of a classification name. The food classification of each of the different brands of sugars that are identified by different food codes are all set as “sugar”. Specifically, in the data record DR3 associated with each of the plurality of brands of sugars, the food code and the food name corresponding to the corresponding food are set in the fields F31 and F32. Meanwhile, in each data record DR3, the classification code for identifying the food classification of “sugar” and the classification name of “sugar” are set in the fields F33 and F34. Other examples of the food classification include “wings”, “mackerel”, “soy sauce”, “vinegar”, “miso”, “sake”, “garlic”, and “ginger”.

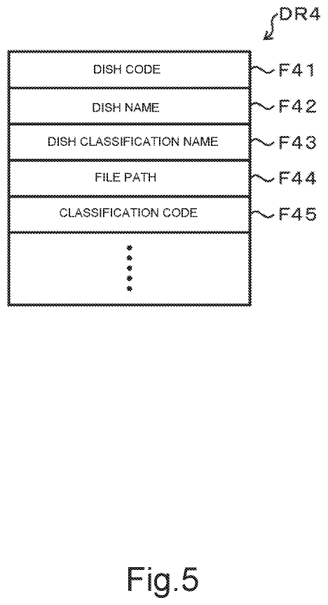

FIG. 5 is a diagram schematically showing a structure of a data record DR4 included in the dish database DB4. The dish database DB4 is a set of data records DR4 having the structure shown in FIG. 5. One data record DR4 is associated with one dish. The data record DR4 includes fields F41, F42, F43, F44, F45, . . . .

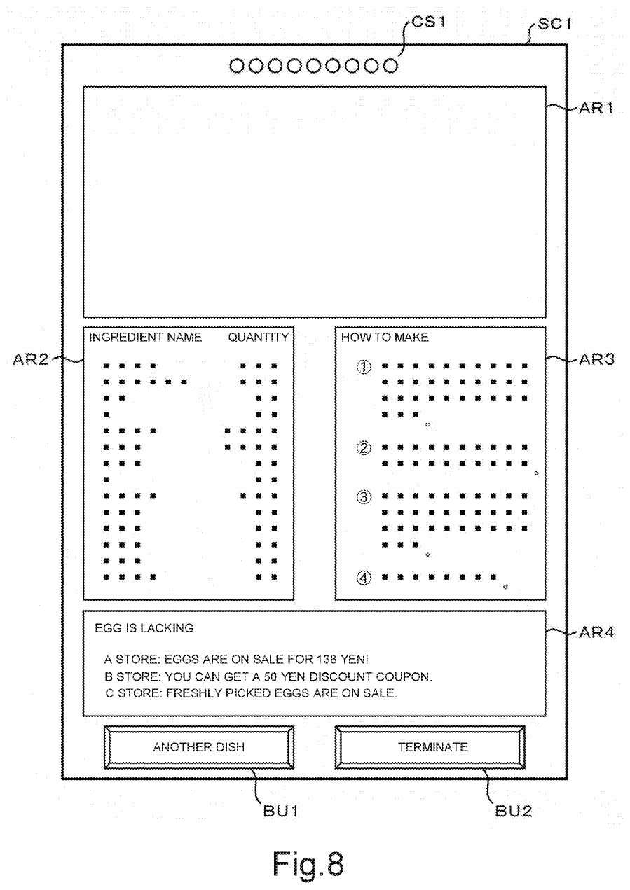

In the field F41, a dish code for identifying the dish associated with the data record DR4 is set. In the field F42, the name (dish name) of the dish associated with the data record DR4 is set. In the field F43, the name of the dish classification to which the dish associated with the data record DR4 belongs is set. For example, “pasta” is an example of the dish classification name. In the field F44, a file path for specifying, for example, the data file of the screen (see FIG. 8) to be displayed on the touch panel 14 of the refrigerator terminal 10 in order to propose the dish associated with the data record DR4 to the user is set. In each of the field F45 and subsequent fields, the classification code of each of the foods to be used as ingredients for cooking the dish associated with the data record DR4 is set. Specifically, the number of the field F45 and subsequent fields differs depending on the number of classifications of the foods to be used as ingredients.

Note that the content of data included in the store database DB1, the user database DB2, the food database DB3, and the dish database DB4 is appropriately set by an arbitrary setter. The store database DB1, the user database DB2, the food database DB3, and the dish database DB4 may include a filed other than the fields described above, and does not necessarily need to include a part of the fields described above. The store database DB1, the user database DB2, the food database DB3, or the dish database DB4 may be stored in a storage device provided outside the information providing server 20 as long as the processor 21 is capable of accessing the database.

Next, the operation of the information providing system 100 configured as described above will be described. Note that the content of processing described below is merely an example, and various types of processing capable of achieving similar results can be appropriately used.

First, in the refrigerator terminal 10, the processor 11 generates, on the basis of the detection result by various sensor included in the sensor group 15, a list (hereinafter, referred to as the food list) of foods stored in the refrigerator 1. The processor 11 stores data indicating the food list in the main memory 12 or the auxiliary storage device 13. The processor 11 repeatedly executes generation of the list and storage of the generate list at regular time intervals, for example. Note that for example, a known technology can be used for such a function of generating the food list. The foods stored in the refrigerator 1 arranged in the home of the user are foods that the user has. In other words, the food list corresponds to the list of the foods that the user has.

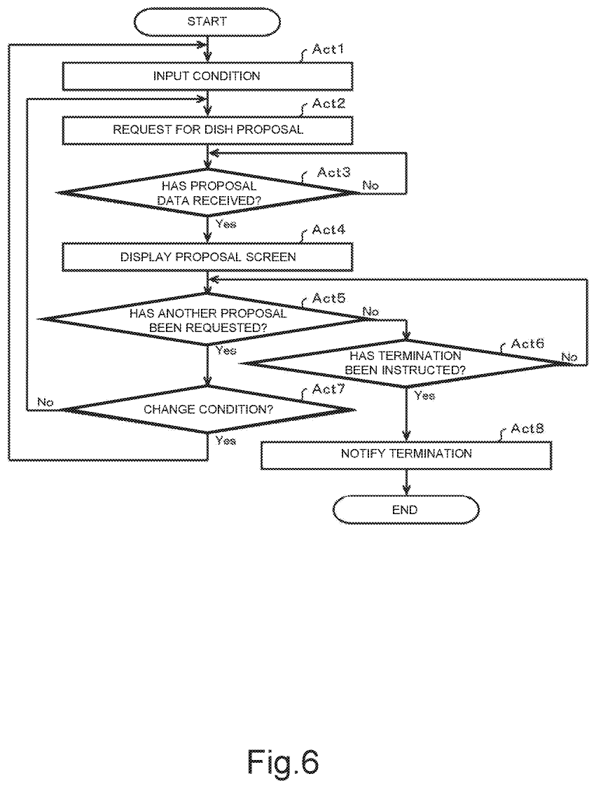

Further, the processor 11 starts information processing for a dish proposal described below when an instruction to start browsing a recommended dish by a user operation via the touch panel 14. FIG. 6 is a flowchart illustrating a procedure of information processing related to the dish proposal by the processor 11 of the refrigerator terminal 10. The processor 11 executes the information processing related to the dish proposal in accordance with the information processing program stored in the main memory 12 or the auxiliary storage device 13.

In Act1, the processor 11 of the refrigerator terminal 10 inputs conditions for narrowing down dishes. For example, the processor 11 displays a GUI screen for designating a condition on the touch panel 14 and inputs a condition in accordance with a user operation via the touch panel 14. Examples of the condition to be input include the dish classification name (e.g., “pasta”). The condition to be input may be, for example, the difficulty of cooking or a necessary time period. Further, the condition to be input may include a plurality of conditions. Note that what conditions the processor 11 inputs may be arbitrarily determined by the creator of the information processing program related to the information processing shown in FIG. 6, or the like.

In Act2, the processor 11 requests the information providing server 20 for a dish proposal. In order to request the above-mentioned dish proposal, for example, the processor transmits, from the communication interface 16 to the communication network 40, request data including the condition data indicating the condition input in Act1 and the above-mentioned food list, which is addressed to the information providing server 20. When the request data is transmitted to the information providing server 20 via the communication network 40, the communication interface 24 of the information providing server 20 receives the request data. Then, in accordance with the request data, the processor 21 starts the information processing for the dish proposal of the information providing server 20, which will be described below.

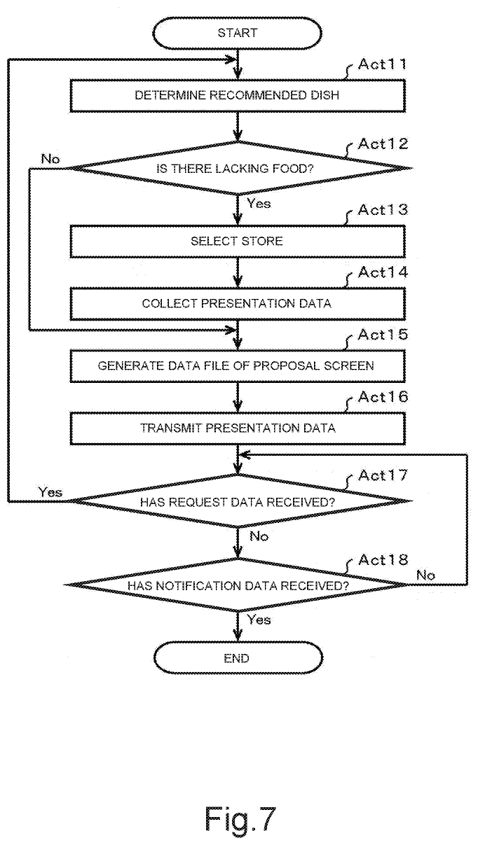

FIG. 7 is a flowchart illustrating a procedure of the information processing related to the dish proposal by the processor 21 of the information providing server 20. The processor 21 executes the information processing related to the dish proposal in accordance with the information processing program stored in the main memory 22 or the auxiliary storage device 23.

In Act11, the processor 21 determines a recommended dish on the basis of the above-mentioned request data (see Act2) transmitted from the refrigerator terminal 10. For example, the processor 21 determines, as a recommended dish, a dish that satisfies the condition indicated by the condition data included in the request data and is suitable for cooking using the food shown in the food list included in the request data. Note that an arbitrary algorithm can be used to determine the recommended dish, and the algorithm may be arbitrarily determined by the creator of the information processing program related to the information processing shown in FIG. 7, or the like. For example, the processor 21 obtains, for each of the plurality of data records DR4 included in the dish database DB4, the ratio of the food that belongs to the food classification identified by the classification code among classification codes (see FIG. 5) set in field F45 and subsequent fields to the foods included in the food list. Then, the processor 21 determines, as a recommended dish candidate, the dish associated with the data record DR4 having the ratio that is equal to or larger than a predetermined threshold value. In the case where a plurality of recommended dish candidates are found, the processor 21 narrows down the recommended dish candidates on the basis of the condition indicated by the condition data. For example, the processor 21 leaves, as the recommended dish candidate, the dish associated with the data record DR4 in which the same dish classification name as that indicated by the condition data is set in the field F43, and excludes other dishes from the recommended dish candidate. Then, for example, if the processor 21 cannot narrow down the recommended dishes to one on the basis of the condition indicated by the condition data, the processor 21 determines one of the recommended dish candidates as the recommended dish in accordance with a predetermined rule. Note that it is favorable to determine the data structure of the data record DR4 of the dish database DB4 in advance so that information necessary for determining the recommended dish is included. Specifically, for example, in the case where the condition data includes the difficulty of cooking or a necessary time period as described above and the difficulty of cooking or the necessary time period is referred to for determining the recommended dish, the data record DR4 is caused to include a field in which the difficulty of cooking or a necessary time period is to be set. Meanwhile, the processor 21 determines, as the recommended dish, not only the dish whose foods as ingredients necessary for cooking are all included in the food list but also the dish whose foods as ingredients necessary for cooking are not partially included in the food list. In other words, on the basis of the food list, which is a list of foods that the user (customer) has, the processor 21 determines, as the recommended dish, the dish suitable for cooking using the foods. The processor 21 executes the information processing based on the information processing program in this way, and thus, the computer including the processor 21 as the brain functions as a determination means for determining the recommended dish. Note that the recommended dish can be determined by using, for example, a known algorithm such as an artificial intelligence (AI) technology.

Next, in Act12, the processor 21 checks whether or not there is a food (hereinafter, referred to as the lacking food) that is lacking for cooking the recommended dish in the foods stored in the refrigerator 1 in which the refrigerator terminal 10 that is a request source of the dish proposal is provided. For example, the processor 21 checks, for each of classification codes set in the field F45 and subsequent fields of the data record DR4 associated with the recommended dish, whether or not the food that belongs to the food classification identified by the classification code is included in the above-mentioned food list. The processor 21 selects, on the basis of the checking result, the food (lacking food) that is not included in the food list among the foods to be used for cooking the recommended dish. The processor 21 executes the information processing based on the information processing program in this way, and thus, the computer including the processor 21 as the brain functions as a selection means for selecting the lacking food. Note that it is favorable to execute the checking in Act12 for only the classification code to which the food stored in the refrigerator 1 belongs among the classification codes set in the field F45 and subsequent fields of the data record DR4. For this purpose, for example, a database storing the food list of the classification code for the food classification to which the food stored in the refrigerator 1 belongs is prepared in advance, and the processor 21 only needs to refer to the database. Note that even in the case of the food that belongs to the same food classification, whether or not the food is stored in the refrigerator 1 differs for each user in some cases. In view of the above, it is favorable that the above-mentioned food list is changeable in accordance with a user instruction. Specifically, the processor 21 selects, as the lacking food, the food that is not included in the food list among the foods to be used for cooking the recommended dish.

In the case where the processor 21 has selected a lacking (missing) food, i.e., in the case where there has been a lacking food (Yes in Act12), the processing of the processor 21 proceeds to Act13. In Act13, the processor 21 selects a store for which data regarding the lacking food is to be collected. First, for example, the processor 21 selects, from the data records DR2 (see FIG. 3) included in the user database DB2, the data record DR2 in which the terminal code of the refrigerator terminal 10 that is the request source of the dish proposal is set in the field F25. The processor 21 extracts, from the store database DB1, the data record DR1 (see FIG. 2) in which the location of the store having a predetermined relationship with the residence of the user set in the field F23 of the selected data record DR2 is set in the field F13. Then, the processor 21 selects, as the store for data collection, the store associated with the extracted data record DR1. Note that for example, in the case where the distance between the residence of the user and the location of the store is equal to or less than a predetermined distance, the processor 21 determines that the residence of the user and the location of the store are in the predetermined relationship. Alternatively, for example, in the case where the residence of the user and the location of the store belong to the same district, or in the case where the residence of the user and the location of the store belong to the same district or adjacent districts, the processor 21 determines that the residence of the user and the location of the store are in the predetermined relationship. However, the specific processing for the determination may be arbitrarily determined by the creator of the information processing program related to the information processing shown in FIG. 7.

In Act14, the processor 21 acquires and collects, from the store selected in Act13, data (hereinafter, referred to as the presentation data) to be presented from the store to the user. For example, the processor 21 transmits, from the communication interface 24 to the communication network 40, request data for requesting transmission of the presentation data, which is addressed to the store server 30 of the store selected in Act13. Note that the processor 21 causes the above-mentioned request data to include the classification code of the food classification to which the lacking food belongs. In the case where the store server 30 receives the request data transmitted from the communication network 40, the store server 30 returns response data to the information providing server 20. For example, in the case where the store server 30 has the presentation data to be presented to the user, the store server 30 causes the above-mentioned response data to include the presentation data. For example, the store server 30 causes the response data to include the presentation data including special sale information regarding the food that belongs to the food classification identified by the classification code included in the request data for requesting transmission of the presentation data. Further, for example, the store server 30 causes the response data to include the presentation data including an image of a coupon for the food that belongs to the food classification identified by the classification code included in the request data for requesting transmission of the presentation data. In other words, the presentation data includes useful information (sales information) for the user when obtaining the lacking food, which is useful for sales promotion of the store. Note that what kind of data is used as the presentation data may be arbitrarily determined by the seller (e.g., store) of the food. Further, the store server 30 may change the presentation data depending on the user. For example, for users who have approved the disclosure of personal information such as age and gender, the information providing server 20 causes the request data (request data for requesting transmission of the presentation data) to include personal information. For example, in the case where the request data includes personal information, the store server 30 causes the response data to include the presentation data including an image of a coupon with a large discount amount as compared with the case where the request data includes no personal information. Then, the processor 21 receives the response data transmitted from each of the store servers 30 that is the transmission destination of the request data. Then, the processor 21 extracts the presentation data included in the response data, and stores the extracted presentation data in the main memory 22 or the auxiliary storage device 23. The processor 21 executes the information processing based on the information processing program in this way, and thus, the computer including the processor 21 as the brain functions as an acquisition means for acquiring the presentation data.

In Act15, in order to propose a recommended dish to the user, the processor 21 generates a data file of a proposal screen to be displayed on the touch panel 14 of the refrigerator terminal 10. FIG. 8 is a diagram showing the proposal screen. A proposal screen SC1 shown in FIG. 8 is an example in the case where a dish having the name “000000000” is determined as a recommended dish. Note that although “0” is actually an arbitrary character, it is simplified and shown in FIG. 8.

The proposal screen SC1 includes a character string CS1, areas AR1, AR2, AR3, and AR4, and buttons BU1 and BU2. The character string CS1 represents the name of the recommended dish. The area AR1 displays an image of recommended dish that has been cooked. Note that illustration of the content of the image is omitted in FIG. 8. The area AR2 displays a list of names of foods (ingredient name) that are ingredients necessary for cooking the recommended dish and a necessary amount (quantity) of each food. The area AR3 displays a sentence (how to make) indicating the cooking procedure. Note that in FIG. 8, a part of the characters in the areas AR2 and AR3 is simplified by being replaced with “.” and shown. The area AR4 displays the classification name of the food classification to which the lacking food belongs and the collected presentation data. In other words, the proposal screen SC1 is an example in the case where the classification name of the food classification to which the lacking food belongs is “egg”. Further, the proposal screen SC1 is an example in the case where the presentation data indicating the character message “Eggs are on sale for 138 yen!” has been collected from the store server 30 associated with the store having the store name “A store”. Further, the proposal screen SC1 is an example in the case where the presentation data indicating the character message “You can get a 50 yen discount coupon” has been collected from the store server 30 associated with the store having the store name “B store”. Further, the proposal screen SC1 is an example in the case where the presentation data indicating the character message “Freshly picked eggs are on sale” has been collected from the store server 30 associated with the store having the store name “C store”. In the example shown in FIG. 8, the presentation data of each of the plurality of stores side is displayed side by side in the area AR4, making it possible for the user to check the content of the presentation data while comparing the content of the pieces of presentation data. The button BU1 is a graphical user interface (GUI) for the user to request a proposal of another recommended dish. The button BU2 is a GUI for the user to designate to terminate the display of the proposal screen.

The processor 21 uses, for example, a data file prepared in advance in association with the recommended dish as a data file for displaying the character string CS1, the areas AR1, AR2, and AR3, and the buttons BU1 and BU2 in the proposal screen SC1. The data file is a file specified by the file path set in the field F44 of the data record DR4 associated with the recommended dish. Further, the processor 21 generates the data file of the proposal screen SC1 by adding the area AR4 created on the basis of the collected presentation data to the above-mentioned data file of the screen displaying the character string CS1, the areas AR1, AR2, and AR3, and the buttons BU1 and BU2 included in the data file. Note that in the case where a link is set to the character string in the presentation data, the processor 21 may generate such a data file of the proposal screen SC1 that causes the browser to access the link in response to clicking of the corresponding character string. Further, in the case where the presentation data includes image data, the processor 21 may generate such a data file of the proposal screen that displays the image indicated by the image data in the area AR4. In addition, the processor 21 may display various types of information in the area AR4 in accordance with the presentation data.

In Act16, the processor 21 transmits proposal data including the generated data file of the proposal screen SC1. For example, the processor 21 transmits, from the communication interface 24 to the communication network 40, the proposal data addressed to the refrigerator terminal 10 that is the request source. The data to be displayed on the character string CS1 and the areas AR1, AR2, and AR3 in the proposal screen SC1 corresponds to the dish data regarding the recommended dish. In other words, the dish data includes data (data of the character string CS1) regarding the name of the dish, data (data of the area AR1) regarding the image of the dish, data (data of the area AR2) of the food that is an ingredient necessary for the dish, and data (data of the area AR3) regarding how to make the dish. Further, the data to be displayed on the area AR4 includes the presentation data. In other words, the presentation data includes the sales data (data of the area AR4) of the store regarding the lacking food. Specifically, transmitting the proposal data including the data file of the proposal screen SC1 to the refrigerator terminal 10 corresponds to outputting the dish data and the presentation data to the refrigerator terminal 10. The processor 21 executes the information processing based on the information processing program in this way, and thus, the computer including the processor 21 as the brain functions as an output means. In the case where the proposal data is transmitted to the refrigerator terminal 10 via the communication network 40, the communication interface 16 receives the proposal data.

After the processor 11 requests a dish proposal in Act2 in FIG. 6, the processing of the processor 11 proceeds to Act3. In Act3, the processor 11 stands by until the above-mentioned proposal data is received by determining whether or not the proposal data has been received. In the case where the processor 11 determines that the proposal data has been received by the communication interface 16 (Yes in Act3), the processing of the processor 11 proceeds to Act4. In Act4, the processor 11 uses the data filed included in the proposal data to display the proposal screen SC1 on the touch panel 14.

In Act5, the processor 11 checks whether or not the user has requested a proposal of another recommended dish. In the case where the processor 11 has checked that a proposal of another recommended dish has not been requested (No in Act5), the processing of the processor 11 proceeds to Act6. In Act6, the processor 11 checks whether or not termination of the display of the proposal screen SC1 has been instructed. In the case where the processor 11 has checked that termination of the display of the proposal screen SC1 has not been instructed (No in Act6), the processing of the processor 11 returns to Act5. In this way, the processor 11 stands by until a proposal of another recommended dish is requested or termination of the display of the proposal screen SC1 is instructed in Act5 and Act6.

In the case where the recommended dish displayed on the proposal screen SC1 of the touch panel 14 is not a desired dish and the user desires to receive a proposal of another recommended dish, the user requests that by a predetermined operation such as touching the button BU1 (see FIG. 8). Further, in the case where the user desires to terminate the display of the proposal screen SC1, the user instructs that by a predetermined operation such as touching the button BU2 (see FIG. 8).

In the case where the processor 11 has checked that a proposal of another recommended dish has been recommended as described above (Yes in Act5), the processing of the processor 11 proceeds to Act7. In Act7, the processor 11 checks whether to change the condition for narrowing down dishes. For example, the processor 11 displays a screen for instructing whether to change the condition on the touch panel 14, and checks whether or not the user has instructed to change the condition through the screen. In the case where the processor 11 has checked that the user has instructed to change the condition (Yes in Act7), the processing of the processor 11 returns to Act1. Then, the processor 11 repeats the processing of Act1 and subsequent Acts in the same way as described above. Further, in the case where the processor 11 has checked that the user has not instructed to change the condition (No in Act7), the processing of the processor 11 returns to Act2. Then, the processor 11 repeats the processing of Act2 and subsequent Acts in the same way as described above. In this way, in any case, the processor 11 requests a dish proposal again in Act2. Specifically, the processor 11 transmits request data for requesting a dish proposal again.

In the case where the processor 11 has checked that termination of the display of the proposal screen SC1 has been instructed as described above (Yes in Act6), the processing of the processor 11 proceeds to Act8. In Act8, the processor 11 notifies the information providing server 20 of termination of browsing the recommended dish (display of the proposal screen SC1). For example, the processor 11 transmits, from the communication interface 16 to the communication network 40, predetermined notification data for notifying the termination of display of the proposal screen SC1, which is addressed to the information providing server 20. In the case where the notification data is transmitted to the information providing server 20 via the communication network 40, the communication interface 24 receives the notification data. Note that at this time, the processor 11 terminates the display of the proposal screen SC1 on the touch panel 14.

After the processor 21 of the information providing server 20 transmits the proposal data as described above in Act16 in FIG. 7, the processing of the processor 21 proceeds to Act17. In Act17, the processor 21 checks whether or not the request data for requesting a dish proposal has been received. In the case where the processor 21 has checked that the request data for requesting a dish proposal has not been received (No in Act17), the processing of the processor 21 proceeds to Act18. In Act18, the processor 21 checks whether or not the above-mentioned notification data (see Act8) for notifying the termination of display of the proposal screen SC1 has been received. In the case where the processor 21 has checked that the notification data for notifying termination has not been received (No in Act18), the processing of the processor 21 returns to Act17. In this way, the processor 21 stands by until the request data for requesting a dish proposal or notification data for notifying termination is received in Act17 and Act18.

In the case where the processor 21 has checked that the request data transmitted again from the refrigerator terminal has been received by the communication interface 24 as described above (Yes in Act17), the processing of the processor 21 returns to Act11. Then, the processor 21 repeats the processing of Act11 and subsequent Acts in the same way as described above. At this time, i.e., while the processing of Act11 to Act17 is repeated, the processor 21 determines, as a recommended dish, a dish different from the dish determined so far in Act11. In this way, the processor 11 transmits, to the refrigerator terminal 10, proposal data indicating the proposal screen SC1 that proposes a different recommended dish that has not been proposed so far. As a result, the proposal screen SC1 displayed on the touch panel 14 of the refrigerator terminal 10 is changed to a screen that proposes the different recommended dish. Meanwhile, in the case where the processor 21 has checked that the notification data has been received by the communication interface 24 as described above (Yes in Act18), the processor 21 terminates the information processing shown in FIG. 7.

As described above, in accordance with the information providing server 20, it is possible to propose a dish to a user and provide information regarding purchase of a food item (missing food item/ingredient) that is lacking but required for cooking the dish that can be provided from the seller (e.g., store) of the food to the user. As a result, in the case where the user adds the lacking food to cook the proposed dish, the user can refer to the information provided by the seller. Further, the seller of the food is thus capable of promoting sales.

Further, when the information providing server 20 collects the presentation data provided by the seller, the information providing server 20 does not give personal information of the user to the seller of the food in principle. Therefore, even a user who does not like that his/her personal information is to be widely transmitted to sellers can use the service with peace of mind.

Further, the information providing server 20 collects presentation data from a plurality of stores, and presents the collected presentation data to the user. Therefore, the user is capable of deciding at which store he/she purchases the food while comparing the plurality of stores.

Further, the information providing server 20 displays the presentation data collected from the plurality of stores side by side on one proposal screen SC1, thereby presenting the presentation data to the user in a comparable manner. Therefore, the user is capable of easily comparing the plurality of stores.

This example embodiment can be variously modified as follows. The food list referred to for determining a recommended dish does not necessarily need to be a list of the foods stored in the refrigerator 1 and may be created in any way. For example, the food list may be a list of the foods stored in a food storage apparatus other than the refrigerator 1 or a list of the foods that a user has in his/her home. Also the method of creating the food list does not necessarily need to be automatically created on the basis of the detection results by the sensor or the like, and may be updated in accordance with a user instruction. Therefore, the information providing server 20 may acquire a food list from an arbitrary information processing terminal different from the refrigerator terminal 10.

The output of the dish data and the presentation data to the refrigerator terminal 10 may be a data file for separate screens displaying them individually. In this case, the refrigerator terminal 10 may simultaneously display the two screens based on different pieces of data side by side on the touch panel 14 or may display the two screens separately on the touch panel 14 by switching the screens. Further, the dish data and the presentation data do not necessarily need to be output as a data file for display a screen. The refrigerator terminal 10 may generate the proposal screen on the basis of the dish data and the presentation data.

The information processing terminal that is an output destination for the dish data and the presentation data may be different from the information processing terminal from which the food list has been acquired. For example, the processor 21 may set the transmission destination for the proposal data in Act16 to a smartphone designated by the user. Alternatively, the processor 21 may cause the transmission destinations for the dish data and the presentation data to be different from each other. For example, the processor 21 may transmit the dish data to the refrigerator terminal 10 and transmit the presentation data to the above-mentioned smartphone.

The processor 21 may omit the processing of Act13 shown in FIG. 7, and set all the store servers 30 to stores for which the presentation data is to be collected in Act14.

A part or all of the functions realized by the processor 21 by information processing can also be realized by hardware that executes information processing not based on a program, such as a logic circuit. Further, each of the above-mentioned functions can also be realized by combining the above-mentioned hardware such as a logic circuit with software control.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information providing server, which performs an information providing service for providing information regarding a recommended dish suitable for cooking using a food that a customer has, the information providing server comprising:
a communication interface that communicates with an information processing terminal and a store server, the information processing terminal managing the food that the customer has, the store server managing a store that sells a food;
a storage device that stores a dish database, the dish database including a plurality of data records associated with a plurality of dishes, a classification code being set in each of the plurality of data records, the classification code being capable of identifying a food necessary for cooking the dish associated with the corresponding data record;
a memory that stores an information processing program for performing the information providing service; and
a processor that, in accordance with the information processing program:
acquires, from the information processing terminal via the communication interface, a list of classification codes each capable of identifying the food that the customer has,
determines the recommended dish on a basis of the classification codes of the list and the classification code set in each of the plurality of data records of the dish database,
selects, on a basis of the classification codes of the list and the classification code set in the data record associated with the determined recommended dish, a food that is lacking for cooking the determined recommended dish using the food that the customer has,
acquires, from the store server via the communication interface, sales information regarding the selected lacking food in a store, and
outputs, to the information processing terminal via the communication interface, dish data regarding the determined recommended dish and presentation data including the acquired sales information.

2. The information providing server according to claim 1, wherein
the list is generated by the information processing terminal provided in a food storage apparatus storing the food that the customer has on a basis of the food stored in the food storage apparatus, and
the processor transmits the dish data and the presentation data to the information processing terminal provided in the food storage apparatus.

3. The information providing server according to claim 1, wherein the processor acquires, from the store server via the communication interface, presentation data including sales information regarding the selected lacking food in a plurality of stores.

4. The information providing server according to claim 3, wherein the processor transmits, to the information processing server, a data file of a screen for displaying the presentation data including the sales information in the plurality of stores in a comparable manner.

5. An information providing method for an information providing server, which performs an information providing service for providing information regarding a recommended dish suitable for cooking using a food that a customer has, the information providing server including
a communication interface that communicates with an information processing terminal and a store server, the information processing terminal managing the food that the customer has, the store server managing a store that sells a food, and
a storage device that stores a dish database, the dish database including a plurality of data records associated with a plurality of dishes, a classification code being set in each of the plurality of data records, the classification code being capable of identifying a food necessary for cooking the dish associated with the corresponding data record, the information providing method comprising:
acquiring, from the information processing terminal via the communication interface, a list of classification codes each capable of identifying the food that the customer has;
determining the recommended dish on a basis of the classification codes of the list and the classification code set in each of the plurality of data records of the dish database;
selecting, on a basis of the classification codes of the list and the classification code set in the data record associated with the determined recommended dish, a food that is lacking for cooking the determined recommended dish using the food that the customer has;
acquiring, from the store server via the communication interface, sales information regarding the selected lacking food in a store; and
transmitting, to the information processing terminal via the communication interface, dish data regarding the determined recommended dish and presentation data including the acquired sales information.

6. An information processing terminal, which manages a food that a customer has, the information processing terminal comprising:
a communication interface that communicates with an information providing server providing information regarding a recommended dish suitable for cooking using the food that the customer has;
a display device that displays information regarding the recommended dish;
a sensor that detects the food that the customer has;
a storage device that stores a list of foods that the customer has;
a memory that stores an information processing program for managing the food that the customer has; and
a processor that, in accordance with the information processing program:
generates the list of foods on a basis of a detection result of the sensor,
stores the generated list of foods in the storage device,
transmits, to the information providing server via the communication interface, request data including the list of foods stored in the storage device to request for the information regarding the recommended dish,
acquires, from the information providing server via the communication interface, dish data regarding the recommended dish and presentation data including sales information regarding a food lacking for cooking the recommended dish in a store that sells the food, as the information regarding the recommended dish, and
displays the acquired dish data and the acquired presentation data on the display device.

7. The information processing terminal according to claim 6, wherein
the information processing terminal is provided in a food storage apparatus storing the food that the customer has,
the sensor detects the food stored in the food storage apparatus, and
the processor generates the list of foods on a basis of a detection result of the sensor.

8. The information processing terminal according to claim 6, wherein the processor acquires, from the information providing server via the communication interface, the presentation data including sales information regarding the lacking food in a plurality of stores.

9. The information processing terminal according to claim 8, wherein the processor displays the presentation data including sales information in the plurality of stores on the display device in a comparable manner.

10. The information processing terminal according to claim 7, wherein the processor repeatedly executes generation of the list of foods and storage of the generated list of foods in the storage device at regular time intervals.
